(19) United States
(12) Patent Application Publication
(10) Pub. No.: US 2025/0059718 A1
(43) Pub. Date: Feb. 20, 2025

(54) RAIL BUFFER

(71) Applicants: Pierre Rene CHENIER, Alexandria (CA); Zacharie Norman CHENIER, Alexandria (CA)

(72) Inventors: Pierre Rene CHENIER, Alexandria (CA); Zacharie Norman CHENIER, Alexandria (CA)

(21) Appl. No.: 18/721,050

(22) PCT Filed: Dec. 19, 2022
(86) PCT No.: PCT/CA2022/051863

§ 371 Date: Jun. 17, 2024

Related U.S. Application Data
(60) Provisional application No. 63/290,903, filed on Dec. 17, 2021.

(51) Int. Cl. E01H 8/10

(52) U.S. Cl. CPC E01H 8/10

(57) ABSTRACT

An apparatus for buffing rails includes a wheel frame having a front end and a back end, and a buffer frame. The buffer frame is pivotably attached to the wheel frame to modulate contact between the buffer heads and the rails. The wheel frame includes two front guide wheels, located on opposing sides of the front end of the frame, and a rear guide wheel located at the back end of the frame. The front guide wheels and the rear guide wheel are configured to engage the rails. The buffer frame includes two circular buffer heads, located at opposing sides of the buffer frame between the front and rear guide wheels. The buffer heads are configured to contact the rails. The buffer frame further includes an engine located at the buffer frame. The engine is configured to drive the rotation of the buffer heads to buffer the rails.

### FIELD

The present disclosure pertains to the field of railway systems and, in particular, to a buffer for use on a railway.

### BACKGROUND

In signalized railways, the majority of the signaling systems and equipment work with either two polarities or a selected frequency going down each rail. Therefore, the equipment depends on a proper connection (also known as a shunt or a short) between the head of the rail and the wheels of the train.

Dust, debris, rust and fallen leaves on the head of the rail can all contribute to a poor connection between the head of the rail and the wheels of the train. In the absence of a proper connection, an electrical resistance may be created in the circuit which can cause severe issues such as short warning times at a road crossing, loss of trains in a signaled approach, among others. To prevent serious incidents/accidents from occurring, rail buffers are used to clean the head of the rail.

Typically, rail buffers are large and cumbersome, with weights exceeding 3000 lbs. These qualities make it especially difficult for one person to both operate the unit and move the equipment on and off the railroad. This increases the cost to perform the job as more people and more equipment (such as a boom truck to get the unit on and off the tracks) are needed. While many prior art rail buffers operate hydraulically or electrically, they are still very large and heavy, making operations difficult, while reducing overall efficiency.

Moreover, hydraulic devices can be very unreliable, and pose problems of their own in cold weather. Hydraulic fluid can become very thick in colder temperatures, thereby causing issues such as the hydraulic pump not being able to draw it efficiently from the reservoir and also allowing for cavitation to occur.

Furthermore, if a hose or any hydraulic component breaks, which is a very common occurrence, it can create a mess that is exceedingly difficult to clean, and it can pollute the environment. Hydraulic leaks may also contaminate the rail itself which could then result in connection (shunting) issues between the rail head and the wheels of the train.

Accordingly, there is a need for a rail buffer that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a rail buffer. In accordance with an aspect of the present invention, there is provided an apparatus for buffing rails of a railway line, the apparatus comprising: a wheel subunit and a buffer subunit. The wheel subunit comprises: a wheel frame having a front end and a back end; two front guide wheels, each of said front guide wheels being located on opposing sides of the front end of the wheel frame, at least one rear guide wheel located at the back end of the frame, wherein the front guide wheels and the at least one rear guide wheel are configured to engage the rails of the railway line; and two transport wheels, each said transport wheel being pivotably attached on opposing sides of the wheel frame via a respective wheel swing arm; The buffer subunit comprises: a buffer frame pivotably attached to the wheel frame; two circular buffer heads, each of said buffer heads being located at opposing sides of the buffer frame between the front guide wheels and the at least one rear guide wheel, wherein the buffer heads are configured to contact the rails; and a motor located on the buffer frame, wherein the motor is configured to drive the rotation of the buffer heads to buffer the rails; wherein the buffer frame is configured to pivot between a first disengaged position and a second buffing position.

Another aspect of the disclosure provides for a buffer system for buffing rails of a railway line. The system includes a buffing apparatus and a lifting platform configured to raise and lower the apparatus onto the rail.

### BRIEF DESCRIPTION OF THE FIGURES

Further features and advantages of the present invention will become apparent from the following detailed description, taken in combination with the appended drawings, in which:

FIG. 1 depicts a front perspective view of a rail buffer, according to one embodiment of the invention.

FIG. 2 depicts a rear perspective view of a rail buffer, according to one embodiment of the invention.

FIG. 3 depicts a left perspective view of a rail buffer, according to one embodiment of the invention.

FIG. 4 depicts a right perspective view of a rail buffer, according to one embodiment of the invention.

FIG. 5 depicts a front left perspective view of a rail buffer, according to one embodiment of the invention.

FIG. 6 depicts a rear left perspective view of a rail buffer, according to one embodiment of the invention.

FIG. 7 depicts a counterweight mechanism, according to one embodiment of the invention.

FIG. 8 depicts the counterweight mechanism of FIG. 6 from another angle.

FIGS. 9 to 11 depict a gear box frame and buffer head for use in a rail buffer, according to one embodiment of the invention.

FIG. 12 depicts a gear box frame and buffer head with brush safety guard for use in a rail buffer, according to one embodiment of the invention.

FIG. 13 depicts an angled gear box and horizontal drive belt for use in a rail buffer, according to one embodiment of the invention.

FIG. 14 depicts the undercarriage, drive belt and clutch of a rail buffer, according to one embodiment of the invention.

FIG. 15 depicts a buffer adjustment lower limit stopper plate for use in a rail buffer, according to one embodiment of the invention.

FIG. 16 depicts a close-up of the buffer adjustment lower limit stopper of FIG. 11.

FIG. 17 depicts a belt tightener rod for use in a rail buffer, according to one embodiment of the invention.

It will be noted that throughout the appended drawings, like features are identified by like reference numerals.

### DETAILED DESCRIPTION

Embodiments of the present invention describe a rail buffer for removing surface contaminants such as dust, debris, rust and fallen leaves from the surface of a rail line. The rail buffer of the present invention is lightweight and compact, thereby increasing its portability and efficiency as a result of its size and compactness. Moreover, due to its compact and lightweight size, the rail buffer may be fully operated by one person, thereby reducing the costs required to complete a rail buffing task. Further, in a preferred embodiment, the rail buffer is fully mechanically driven which is more reliable for colder climates, such as North America, than hydraulic devices.

As used herein, the term “apparatus” is used interchangeably with the term “rail buffer”.

An aspect of the disclosure provides for an apparatus for buffing rails of a railway line. The apparatus includes a wheel frame and a buffer frame pivotably attached to the wheel frame, wherein the pivoting movement of the buffer frame allows for the movement between the buffing position, in which the buffer heads are in contact with the rails during the buffing process, and the disengagement position, in which the buffer heads are raised away from the rails. The pivoting movements of the buffer frame may also be used to modulate contact pressure between the buffer heads and the rails.

The wheel frame includes guide wheels which are configured to contact the rails during deployment for the buffing process. In one embodiment, the wheel frame includes two front guide wheels, each being located on opposing sides of the front end of the frame, and at least one rear guide wheel located at the back end of the frame. In a preferred embodiment, the wheel frame is provided with two rear guide wheels. The guide wheels are each configured to engage the rails of the railway line and are provided with circumferential flanges along the inner and/or outer periphery of the guide wheels ensure that the rail buffer is retained in position on the rails during the buffing process.

The buffer frame includes two circular buffer heads, each buffer head being located at opposing sides of the buffer frame, preferably between the front and rear guide wheels. The buffer heads are configured to contact the rails and rotate with sufficient speed and power to abrade the rails to remove surface contaminants.

The wheel frame further includes two transport wheels which are mounted on respective swing arms mounted on opposing sides of the wheel frame. The transport wheels are configured to pivot between a first transport position and a second buffing position. In the first transport position, the transport wheels are deployed to contact the road and provide rolling support to the apparatus, and in the second buffing position, the transport wheels are raised, allowing the apparatus to be lowered until the guide wheels come into contact with the rails. In one embodiment, the swing arms are mounted on a main pivot shaft, which is driven by two electric linear actuators, controlled by an up or down toggle switch to move the transport wheels between buffing and transport positions. In one embodiment, the swing arms are locked into the transport position using a safety axle lock mechanism.

In some embodiments, the apparatus further comprises a counterweight mechanism configured to facilitate the pivoting movement of the buffer frame between the disengaged position and the buffing position. The counterweight mechanism comprises a counterweight on a counterweight arm, and a retainer catch configured to releasably engage the counterweight arm. When the counterweight arm is engaged by the retainer catch, the buffer frame is held in a first disengaged position with the buffer heads not in contact with the rails. The retainer catch is used to maintain the buffer heads in an elevated position for transportation.

When the counterweight arm is disengaged from the retainer catch, the buffer frame is released and allowed to drop into the second buffing position wherein the buffer heads are in contact with the respective rails.

In one embodiment, the counterweight mechanism is also adjustable to maintain constant contact pressure between the buffer heads and the rails through the application of a desired amount of force. In some embodiments, the counterweight may be adjustable to increase or decrease the contact pressure between the buffer heads and the rails by sliding the counterweight up or down along the length of the counterweight arm. In some embodiments, the counterweight may be manually moved. In one embodiment, the counterweight is set in place through the use of a locking mechanism to prevent movement along the arm. In one embodiment, the locking mechanism is manually set. In other embodiments, the counterweight may be automatically adjusted in conjunction with, for example, a sensor-based system for detecting pressure between the buffer head and rail.

In a preferred embodiment, the counterweight mechanism ensures that the rail buffer maintains constant contact pressure on the rail without requiring periodic readjustment. The apparatus may thus be able to provide a constant buffing wheel-to-rail pressure throughout the entire life of the buffer heads.

This constant pressure technology also uses the counterweight to increase or decrease the pressure of the buffer heads and on a rail depending on how much buffing/polishing is required. In one embodiment, once the desired pressure is achieved, the pressure will remain constant throughout the life of the buffer heads.

In one embodiment, the buffer frame further comprises an adjustable lower limit stopper configured to contact the fixed wheel frame to limit the downward movement of the pivoting buffer frame when in the second buffing position, thus ensuring the optimal contact pressure of the buffer heads on the rails during the buffing process. The lower limit stopper also limits the downward movement of the buffer frame if the brush heads are worn down beyond a set limit.

The buffer frame further includes a motor located on the buffer frame configured to drive the rotation of the buffer heads to buff the rails.

In some embodiments, the motor is configured to drive clutch. The clutch drives a drive belt connected to two gear boxes, each of the gear boxes being connected to and driving a respective buffer head. In a preferred embodiment, the gear box is a right-angle gear box which translates the horizontally oriented drive belt motion output by the motor into a vertically oriented drive belt motion for rotation of the buffer heads. In one embodiment, the buffer head driving mechanism comprises an industrial centrifugal clutch mounted on the crankshaft of a gas-powered engine, which drives two right angle gear boxes, causing rotation of the buffer head brushes. In one embodiment, the drive mechanism further comprises idler deflector pulleys.

In one embodiment, the motor is mounted on a motor support plate located on the buffer frame. In one embodiment, the motor support plate is slidably mounted on the buffer frame. In some embodiments, the apparatus may further comprise a drive belt tightener adjustment screw which controls the position of the support plate relative to the buffer frame, to control the tightness of the motor drive belt.

In one embodiment, the motor is a gas-powered engine. In some embodiments, the motor is an electric motor. In such embodiments, the electric motor may be powered by an onboard battery or by any suitable external electricity source. In one embodiment, the onboard battery may be configured to be charged during transportation of the apparatus, for example, by the battery of the transport vehicle. In one embodiment, the apparatus comprises a battery charger that can charged using a 12 volt power source from the transport vehicle. The battery charger can then be used to charge the onboard battery.

In a preferred embodiment, each buffer head comprises a brush head. In some embodiments, each brush head may comprise one or more wire brushes. In some embodiments, the one or more wire brushes may be three knotted wire brushes arranged in series. In some embodiments, each buffer head is mounted at an angle relative to the direction of motion of the apparatus.

In some embodiments, the gear boxes may be angled gear box operatively connected to a horizontal drive belt driven by the motor. In some embodiments, each gear box is mounted in a rotatable gear box frame, and the angle of the buffer head is adjustable by rotation of the rotatable frame relative to the buffer frame. In some embodiments, the apparatus may further comprise a side adjustment plate to allow for lateral adjustment of the buffer gear box frame to adjust the lateral position of the buffer heads on the rails. In one embodiment, the gear box frames and side adjustment plates are made of a lightweight metal such as aluminum.

In some embodiments, the buffer heads are mounted to the buffer frame by a buffer head shaft and pillow block bearings.

In some embodiments, the framing elements of the wheel frame and buffer frame are made of a lightweight metal such as aluminum.

In a preferred embodiment, the wheel frame at its front end is further provided with a trailer hitch configured to facilitate transport to and from sites by towing behind a vehicle. Since the rail buffer apparatus is preferably manufactured from lightweight materials, heavy duty towing hitches should not be required. In a preferred embodiment, the rail buffer apparatus may be towed using standard trailer hitch systems rated for towing light duty trailers.

In some embodiments, the apparatus further may comprise a camera configured to monitor the rail during the buffing process. This may allow an operator to remotely view the progress of the apparatus in real-time.

Advantages of the embodiments disclosed herein include that the rail buffer is designed to be lightweight and compact, thereby increasing its portability and efficiency as a result of its size and compactness. Further, the rail buffer may be fully mechanically driven which is far more reliable for colder climates, such as North America, than hydraulic devices. Moreover, the rail buffer may be fully operated by a one person, thereby reducing the costs required to complete a rail buffing task.

Another aspect of the disclosure provides for a buffer system for buffing rails of a railway line. The system includes a buffing apparatus and a lifting platform configured to raise and lower the apparatus onto the rail.

In some embodiments, the system may be configured for use with a high rail vehicle. In some embodiments the system may further include a wireless remote-control system configured to control the motor and/or the lifting platform. Thus, an operator may remotely raise or lower the lifting platform of the apparatus, start or stop the motor, and increase or decrease the rotations per minute (RPM) of the motor (thereby controlling the buffing speed).

In some embodiments, the lifting platform may be an automatic lifting platform which operates by the press of a button for moving the apparatus up or down. In some embodiments, the lifting platform may be attached to the hitch of any high rail vehicle (i.e., a vehicle that goes on railway tracks) allowing for attachment to any high rail vehicle to be simple and universal. In some embodiments, all that may be required is to put the high rail vehicle on a railway track and press a button which will cause the lifting platform of the buffer go down on the tracks. Similarly, the press of a button may cause the lifting platform to raise, allowing for removal from the railway tracks.

In some embodiments, the system including the apparatus and the lifting platform may at least in part be controlled by a software application such as, for example, a smartphone application, allowing for greater ease and accessibility in operation of the system.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present invention has been described with reference to specific features and embodiments thereof, it is evident that various modifications and combinations can be made thereto without departing from the invention. The specification and figures are, accordingly, to be regarded simply as an illustration of the invention as defined by the appended claims, and are contemplated to cover any and all modifications, variations, combinations or equivalents that fall within the scope of the present invention.

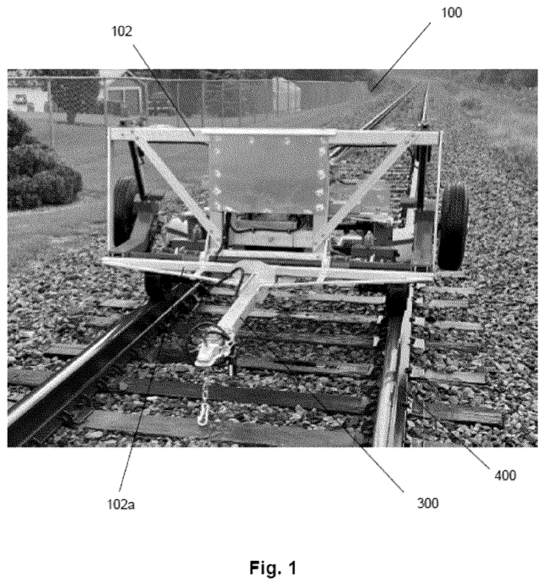

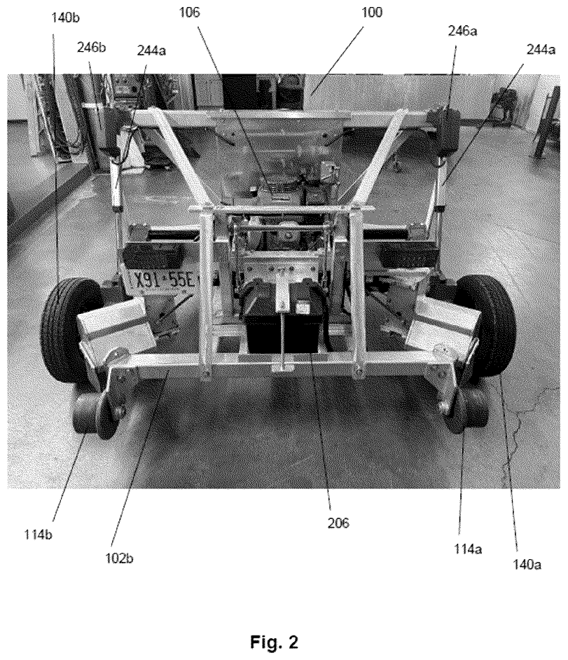

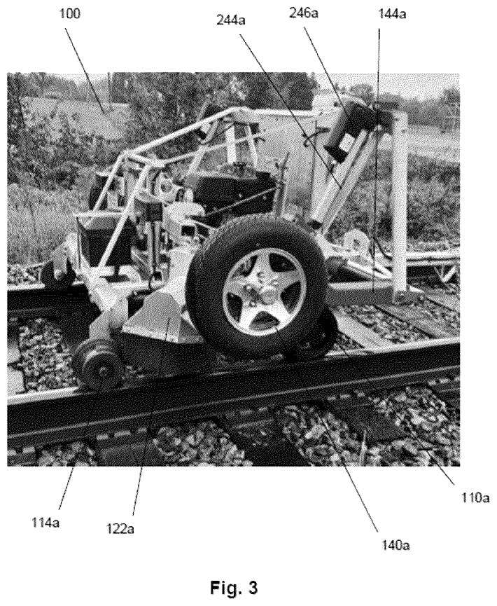

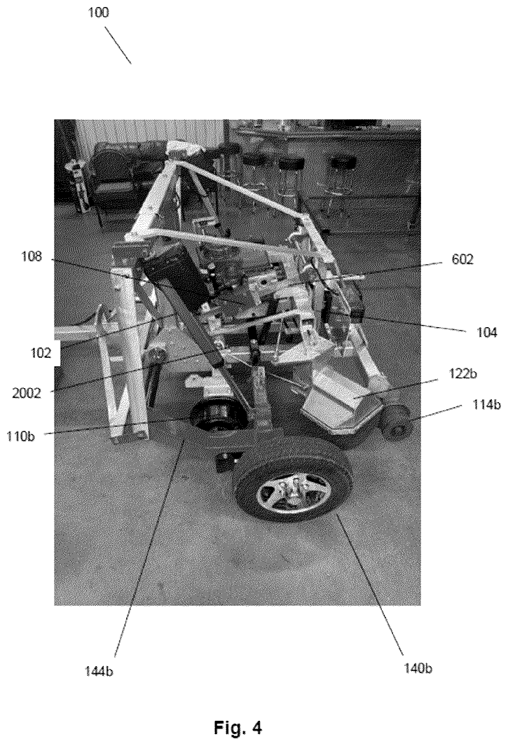

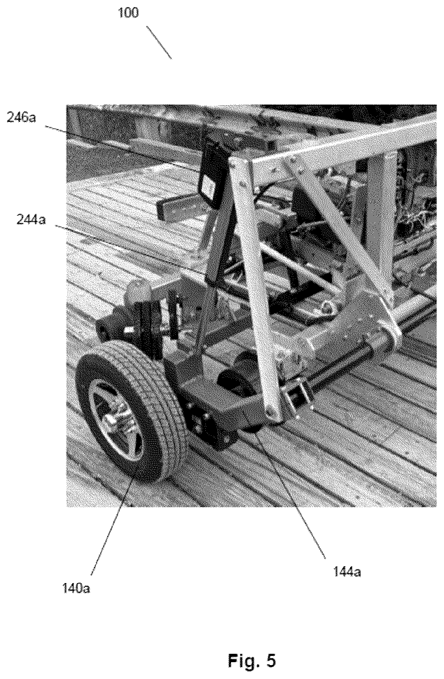

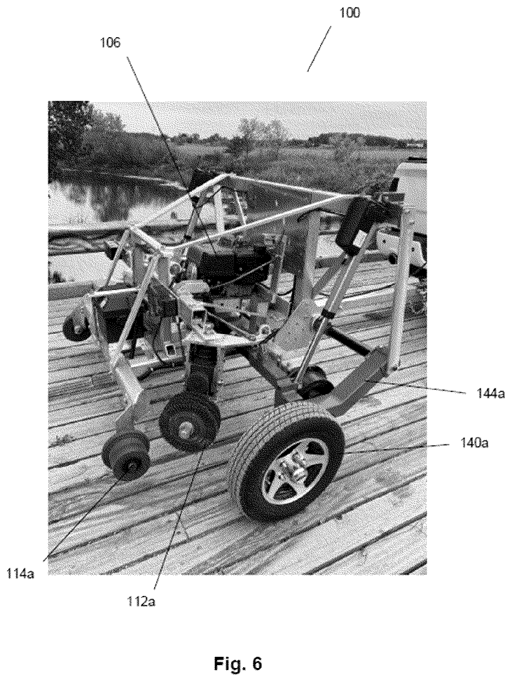

FIGS. 1 to 6 depict an exemplary apparatus 100 for buffing rails of a railway line. FIGS. 1 and 3 depict apparatus 100 as deployed on rail line 400 with transport wheels 140a and 140b in the buffing position, and FIGS. 2 and 4 to 6 depict apparatus 100 with transport wheels 140a and 140b in the transport position.

Apparatus 100 includes a wheel frame 102 having front end 102a and back end 102b, and buffer frame 104 (FIG. 2?). Wheel frame 102 includes two front guide wheels 110a and 110b, each of front guide wheels 110a and 110b being located on opposing sides of the front end 102a of the wheel frame 102, and two rear guide wheels 114a and 114b located at back end 102b of frame 102. Front guide wheels 110a and 110b and rear guide wheels 114a and 114b are configured to engage the rails of the railway line. Buffer frame 104 includes two circular buffer heads 112a and 112b, each of said buffer heads 112a and 112b being located at opposing sides of buffer frame 104 between front guide wheels 110a and 110b and rear guide wheel 114. Buffer heads 112a and 112b are configured to contact the rails. Transport wheels 140a and 140b are attached to wheel frame 102 via respective wheel swing arms 144a and 144b mounted on pivot shafts 244a and 244b, driven by linear actuators 246a and 246b, which can be converted between transport position and buffing position.

Buffer frame 104 further includes motor 106, wherein motor 106 is configured to drive the rotation of buffer heads 112a and 112b to buffer the rails. Buffer frame 104 is pivotably attached to wheel frame 102 to modulate contact between buffer heads 112a and 112b and the rails.

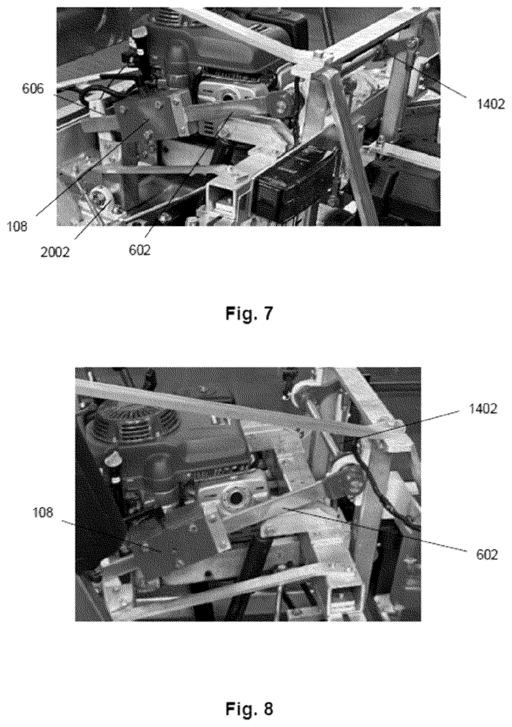

As shown in FIGS. 7 and 8, the apparatus 100 further comprises counterweight 108 configured to maintain suitable contact pressure between buffer heads 112a and 112b and the rails. Also shown in FIG. 7 is a pivot point 2002 between wheel frame 102 and buffer frame 104 in apparatus 100. Moving the counterweight 108 toward the end of the counterweight arm 602 will result in an increase of pressure produced by the buffer heads 112a and 112b.

FIGS. 7 and 8 also depict counterweight rod 1402 operatively connected to the counterweight arm 602 for use with the counterweight 108 used in apparatus 100. Also shown is retainer catch 606, which holds the end of counterweight arm 602 in place during transportation of the apparatus.

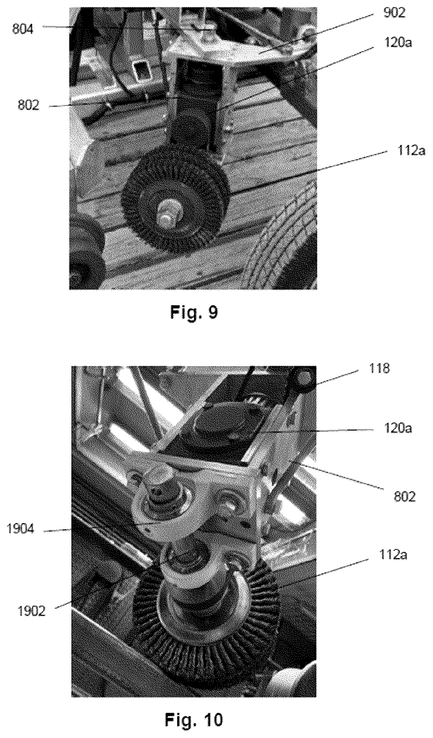

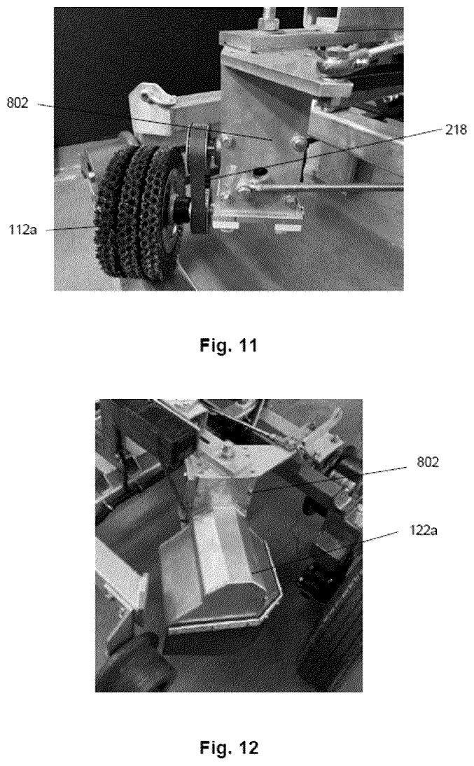

FIGS. 9 to 11 depict gear box frame 802 and associated buffer head 112a, which comprises a brush head. As shown, gear box 120a is connected to and drives buffer head 112a. Gear box 120a is a right-angle gear box.

As shown, buffer head 112a is mounted at an angle relative to the direction of motion of the apparatus 100.

FIG. 10 depicts buffer head shaft 1902 and the pillow block bearings 1904 in apparatus 100.

FIG. 9 depicts pivot point 804, with which the angle of buffer head 112a may be varied.

FIG. 9 also depicts a side adjustment plate 902 for the buffer gear box frame 802 of FIG. 8 in the example apparatus 100. The side adjustment plate 902 allows for side adjustment of the buffer gear box frame 802.

FIG. 12 depicts gear box frame 802 and buffer head (not shown) covered with brush safety guard 122a.

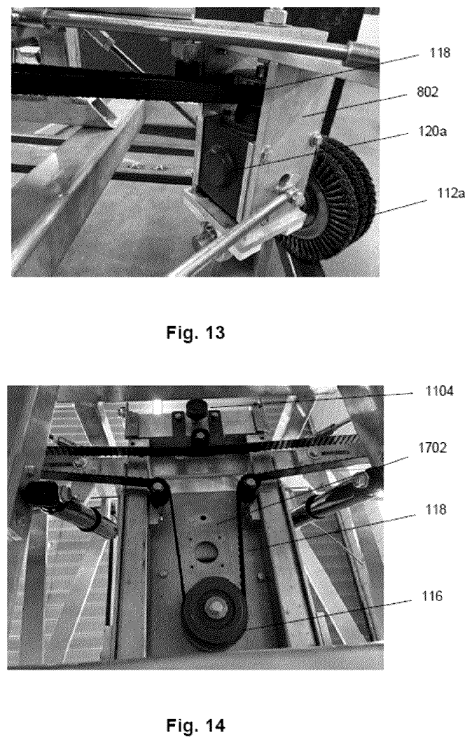

FIG. 13 depicts an angled gear box 120a and horizontal drive belt 118 in apparatus 100. Each gear box 120a and 120b is mounted in a rotatable gear box frame 802, and the angle of the buffer head 112a and 112b is adjustable by rotation of the rotatable frame. FIG. 14 depicts the undercarriage of apparatus 100, including right-angle gear box 120a used to drive buffer head 112a.

As shown in FIG. 14, the motor (not shown) is configured to drive clutch 116. Clutch 116 drives drive belt 118 connected to two gear boxes (not shown). Also shown in FIG. 14 is the underside of motor support plate 1702, on which motor 106 is mounted.

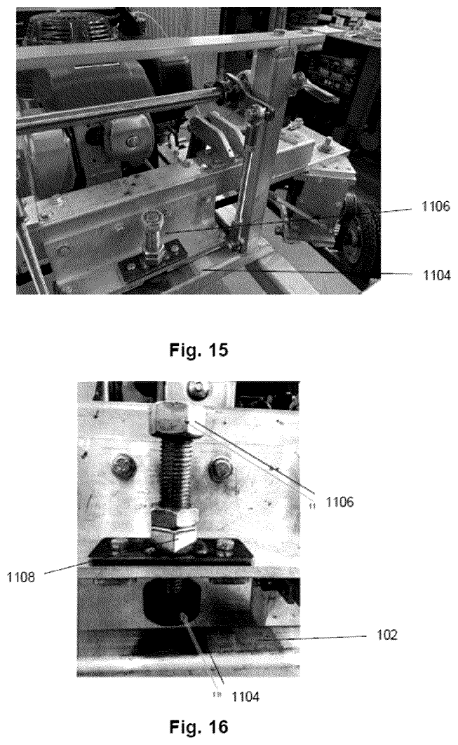

FIG. 15 depicts a buffer frame adjustment lower limit stopper 1104, connected to bolt 1106, as well as locking nuts 1108, configured to secure bolt 1106.

FIG. 16 depicts a close-up of the buffer frame adjustment lower limit rubber stopper 1104 in the example apparatus 100. When the buffer heads 112a and 112b are maximally worn down, the lower limit rubber stopper 1104 will limit further relative movement of the buffer frame 104. Bolt 1106 may also be used to vary the limit of the lower limit rubber stopper 1104.

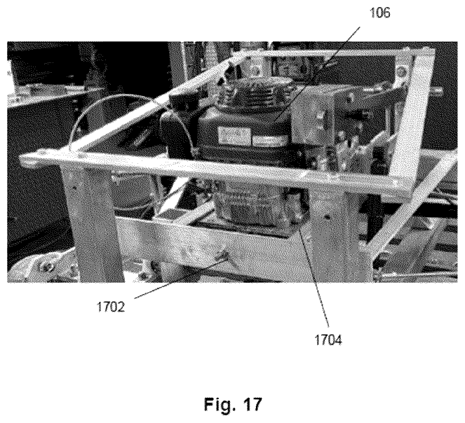

FIG. 17 depicts a belt tightener screw 1702 in apparatus 100. The belt tightener screw 1702 controls the position of a motor support plate 1704 within slide grooves (not shown) to tighten the drive belt 118.

We claim:

1. An apparatus for buffing rails of a railway line, the apparatus comprising:
a wheel subunit comprising:
a wheel frame having a front end and a back end;
two front guide wheels, each of said front guide wheels being located on opposing sides of the front end of the wheel frame,
at least one rear guide wheel located at the back end of the frame, wherein the front guide wheels and the at least one rear guide wheel are configured to engage the rails of the railway line; and
two transport wheels, each said transport wheel being pivotably attached on opposing sides of the wheel frame via a respective wheel swing arm; and
a buffer subunit comprising:
a buffer frame pivotably attached to the wheel frame;
two circular buffer heads, each of said buffer heads being located at opposing sides of the buffer frame between the front guide wheels and the at least one rear guide wheel, wherein the buffer heads are configured to contact the rails; and a motor located on the buffer frame, wherein the motor is configured to drive the rotation of the buffer heads to buffer the rails;
wherein the buffer frame is configured to pivot between a first disengaged position and a second buffing position.

2. The apparatus of claim 1, further comprising a counterweight on a counterweight arm configured to facilitate movement of the buffer frame between the disengaged position and the buffing position, and a retainer catch configured to releasably engage the counterweight arm, wherein when the counterweight arm is engaged by the retainer catch, the buffer frame is held in a first disengaged position, and when the counterweight arm is disengaged, the buffer frame is released into the second buffing position.

3. The apparatus of claim 2, wherein the counterweight is further configured to maintain suitable contact pressure between the buffer heads and the rails.

4. The apparatus of claim 2 or 3, wherein the counterweight is adjustable to increase or decrease the contact pressure between the buffer heads and the rails.

5. The apparatus of any one of claims 1 to 4, wherein the motor is configured to drive a clutch, wherein the clutch drives a drive belt connected to two gear boxes, wherein each of the gear boxes is connected to and drives a respective buffer head.

6. The apparatus of claim 5, wherein the gear box is a right-angle gear box.

7. The apparatus of any one of claims 1 to 6, wherein the motor is mounted on a motor support plate, and wherein the motor support plate is slidably mounted on the buffer frame and the motor support plate is held in place by a belt tightener screw, which controls the position of the support plate relative to the buffer frame, to control the tightness of the motor drive belt.

8. The apparatus of any one of claims 1 to 7, wherein the buffer frame further comprises an adjustable lower limit stopper configured to contact the wheel frame to limit downward movement of the buffer frame when in the second buffing position.

9. The apparatus of any one of claims 1 to 8, wherein the motor is an electric motor.

10. The apparatus of any one of claims 1 to 8, wherein the motor is a gas-powered engine.

11. The apparatus of any one of claims 1 to 10, wherein each buffer head comprises a brush head.

12. The apparatus of claim 11, wherein each brush head comprises one or more wire brushes.

13. The apparatus of claim 12, wherein the one or more wire brushes are three knotted wire brushes connected in series.

14. The apparatus of any one of claims 1 to 13, wherein each buffer head is mounted at an angle relative to the direction of motion of the apparatus.

15. The apparatus of claim 5 or 6, wherein each gear box is mounted in a rotatable gear box frame, and the angle of the buffer head is adjustable by rotation of the rotatable frame.

16. The apparatus of any one of claims 1 to 15, wherein the apparatus further comprises a trailer hitch configured to facilitate transport to and from sites by towing behind a vehicle.

17. The apparatus of any one of claims 1 to 16, wherein the apparatus further comprises a camera configured to monitor the rail during the buffing process.

18. A buffer system for buffing rails of a railway line, wherein the system comprises:
an apparatus as defined in any one of claims 1 to 17; and
a lifting platform configured to raise and lower the apparatus onto the rails.

19. The system of claim 18, wherein the system is configured for use with a high rail vehicle.

20. The system of claim 17 or 18, further comprising a wireless remote-control system configured to control the motor and/or the lifting platform.
